(19) United States
(12) Patent Application Publication
(10) Pub. No.: US 2019/0206288 A1
(43) Pub. Date: Jul. 4, 2019

(54) ARTICLES WITH MOBILE DISPLAYS AND METHODS OF USING THE SAME

(71) Applicant: Ties Co., Ltd., Tokyo (JP)

(72) Inventor: Toshiro Hayashi, Tokyo (JP)

(21) Appl. No.: 16/214,221

(22) Filed: Dec. 10, 2018

Related U.S. Application Data
(63) Continuation of application No. PCT/JP2017/034427, filed on Sep. 25, 2017.

(30) Foreign Application Priority Data
Oct. 16, 2016 (JP) 2016-203183

(51) Int. Cl. G09F 13/04; G09F 23/00; B65D 33/00; B65D 33/10

(52) U.S. Cl. CPC G09F 13/0413; G09F 23/00; G09F 2013/0463; B65D 33/105; B65D 33/004

(57) ABSTRACT

A mobile advertising holder is provided in the form of bag convenient for carrying where a LED tape light is stored. A mobile advertisement holder has an advertisement bag with a strap, and a LED interior illumination device. An advertisement display unit displays an advertisement image is installed in front of the advertisement bag. The LED interior illumination device includes a set box; a plurality of LED tape lights; a mobile battery; and a USB cable. The LED interior illumination device is stored in the advertisement bag so that the plurality of LED tape lights illuminate the advertisement image of the advertisement display unit to display the advertisement image in a novel and eye-catching manner.

### RELATED APPLICATIONS

This application claims priority under 35 U.S.C. § 120 to, and is a continuation of, co-pending International Application PCT/JP2017/034427, filed Sep. 25, 2017 and designating the US, which claims priority to Japanese Application 2016-203183, filed Oct. 16, 2016, such Japanese Application also being claimed priority to under 35 U.S.C. § 119. These Japanese and International applications are incorporated by reference herein in their entireties.

### BACKGROUND

### Field

Example embodiments relate to mobile display holders and method of using the same.

### SUMMARY

A first aspect provides: a mobile advertisement holder 100 having: an advertisement bag 10 with a strap h; and a LED interior illumination device 20. An advertisement display unit 5 that displays an advertisement image KG is installed in front of the advertisement bag 10. The LED interior illumination device comprises: a set box; a plurality of LED tape lights; a mobile battery; and a USB cable. The LED interior illumination device is stored in the advertisement bag so that the plurality of LED tape lights illuminate the advertisement image of the advertisement display unit to display the advertisement image.

A second aspect of example embodiments is to provide: the mobile advertisement holder, wherein the set box is made of paper.

A third aspect of example embodiments is to provide: the mobile advertisement holder, wherein an illumination film is sealed on the advertisement display unit, and the advertisement image is displayed on the illumination film.

A fourth aspect of example embodiments is to provide: the mobile advertisement holder, wherein the advertisement display unit is formed by a sheet material that transmits light.

A fifth aspect of example embodiments is to provide: the mobile advertisement holder, wherein a light diffusion sheet is provided in front of the set box.

A sixth aspect of example embodiments is to provide: the mobile advertisement holder, wherein an inner side of the set box is sealed by silver material.

A seventh aspect of example embodiments is to provide: the mobile advertisement holder, wherein an upper part of the advertisement bag is provided with a cover for preventing transmission of light.

### BRIEF DESCRIPTION OF THE DRAWINGS

Example embodiments will become more apparent by describing, in detail, the attached drawings, wherein like elements are represented by like reference numerals, which are given by way of illustration only and thus do not limit the terms which they depict.

FIG. 1 shows a perspective view of a mobile advertising holder 100.

FIG. 2 shows perspective views of a mobile advertising bag 10 and a LED interior light device 10, where an arrow indicates storing the LED interior light device 20 in the mobile advertising bag 10.

FIG. 3 is a front view of a mobile advertising holder 100.

FIG. 4 is a right side view of a mobile advertising holder 100, where the left side view of the mobile advertising holder 100 is symmetrical and thus omitted.

FIG. 5 is a front view of a LED interior light device 20.

FIG. 6 is a front view of a mobile advertising bag 10.

FIG. 7 is a right side view of a mobile advertising bag 10, where the left side view of the mobile advertising bag 10 is symmetrical and thus omitted.

FIG. 8 is a front view of a LED interior light device 20, illustrating the LED interior light device 20 provided with a light diffusion sheet HS in front of a set box 15.

FIG. 9 is a back view of a mobile advertising bag 10.

FIG. 10 is a front view of a LED interior light device 20, illustrating the LED interior light device 20 not provided with a light diffusion sheet HS in front of a set box 15.

FIG. 11 is a right side view of a LED interior light device 20, where the left side view of the LED interior light device 20 is symmetrical and thus omitted.

FIG. 12 is a perspective view of a LED interior light device 20.

FIG. 13 is a perspective view of a light diffusion sheet HS, where an arrow illustrates an orientation of sealing the light diffusion sheet HS on the frame of the set box 15

FIG. 14 is a perspective view of a tape light TL and a set box 15, where a plurality of LED tape lights TL are arranged and installed on the back of the set box 15 upward/downward, where the LED interior light device 20 is constituted by the tape light TL and the set box 15.

FIG. 15 is a schematic diagram that illustrates connection of a mobile battery PB with a plurality of LED tape lights TL.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

It will be understood that, although the terms first, second, etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments or methods. As used herein, the term “and/or” includes all combinations of one or more of the associated listed items. The use of “etc.” is defined as “et cetera” and indicates the inclusion of all other elements belonging to the same group of the preceding items, in any “and/or” combination(s).

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, the singular forms “a,” “an,” and “the” are intended to include both the singular and plural forms, unless the language explicitly indicates otherwise. It will be further understood that the terms “comprises,” “including,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof. The use of “about” in connection with values indicates effective approximation, and such values may vary within a range having substantially similar activity or functionality. As such, values referred to as “about” include similar values and precisions expected with applicable manufacturing tolerances and unavoidable impurities in the element of the value, and generally would be expected to vary less than 15% of the value itself.

The structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other series of operations aside from single operations described below. It should be presumed that any embodiment or method having features and functionality described below, in any workable combination, falls within the scope of example embodiments.

The Inventors have recognized a first difficulty is to provide with a mobile advertising holder which is novel and eye-catching in the form of bag convenient for carrying where a LED tape light is stored. A second difficulty is to provide with a mobile advertising holder which is novel and eye-catching in the form of bag convenient for carrying where a LED tape light is stored, light enough to reduce burden on a person during carrying. A third difficulty is to provide with a mobile advertising holder which is novel and eye-catching in the form of bag convenient for carrying where a LED tape light is stored, stain-resistant during a long-time usage. A fourth difficulty is to provide with a mobile advertising holder which is novel and eye-catching, erases shades due to a LED tape light, and stores the LED tape light. Example embodiments and methods described below address these and other problems recognized by Inventors with unique solutions enabled by example embodiments.

The present invention is articles with uniquely positions and held displays. In contrast to the present invention, the few example embodiments and example methods discussed below illustrate just a subset of the variety of different configurations that can be used as and/or in connection with the present invention.

The advertisement bag 10 indicates a bag with a strap used for advertisement having a front unit; a back unit; a left side unit; a right side unit; an upper unit; and a bottom unit.

A set box 15 is a box manufactured to form a special shape by hollowing out and bending, generally formed without using paste. Further, the set box 15 is formed by folding its side face and thus is strong. The set box 15 (having a frame) is characteristically difficult to be crushed by overlapping due to the frame and its strength.

The LED tape light TL indicates an illumination device provided with LEDs on a base of a tape by intervals. The width of the tape is typically about 1 cm. LED is more difficult to heat up than typical illumination devices and thus useful for energy saving so that the mobile battery PB can be light-weight and used for an energy supply in a long time. The color can be chosen from white, red, blue, yellow, or various colors.

The power supply of the LED tape light TL is as same as the typical computer power supply in its specification. In this embodiment, the LED tape light TL is formed by connecting the mobile battery PB with the USB cable UC.

Here, USB is an abbreviation of Universal Serial Bus, and means a standard of the interface used for the serial transfer, easily connecting to peripheral devices such as a digital camera and a printer. Like the conventionally used SCSI, the USB allows the devices to be inserted and removed without shutting down the personal computer connected (referred to as “hot-plug”). In other words, USB makes a role of supplying a power from the personal computer to the connected peripheral device possible (bus-power).

The mobile battery PB indicates a portable battery and is categorized to: one having built-in lithium-ion rechargeable battery that allows repeated usage; and a dry cell type used by replacing the dry cells.

The USB cable UC indicates a cable that connects devices of USB standard, one of serial transfer system, allowing power supply from the power source, characterized in being used for connecting a digital camera with a personal computer or a printer.

USB hub indicates a device used to connect a plurality of networking devices of USB standard. In this embodiment, USB hub is a device used for connecting a plurality of LED tape lights TL with a mobile battery PB in parallel using the USB cable UC.

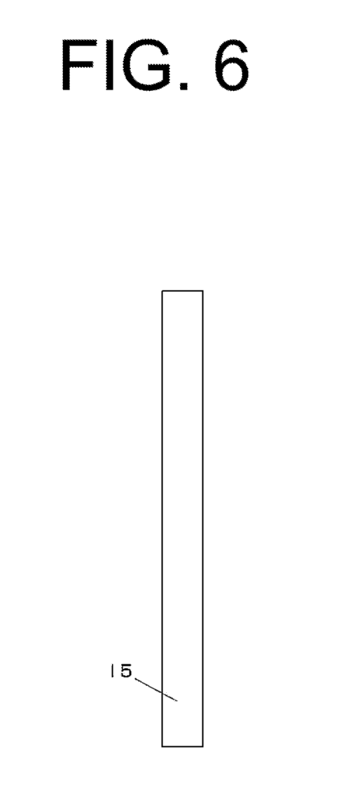

Connection in parallel indicates a plurality of LED tape lights TL are arranged in parallel to planarly arrange a plurality of LED tape lights TL to connect the plurality of LED tape lights TL in parallel with the mobile battery PB using the USB cable C and the USB hub (ref. FIG. 6).

An advertisement display unit 5 indicates a sheet material installed in front of the advertisement bag 10 that transmits light from the LED tape lights TL. By illuminating the advertisement image KG of the advertisement display unit 5, the mobile advertisement holder 100 characteristically displays the advertisement image KG.

The advertisement image KG indicates an image for advertisement including characters, symbols and figures. The advertisement image KG is displayed on the advertisement display unit 5. The light from the LED tape lights TL allows the advertisement image KG to be illuminated to display the advertisement image KG.

For example, the advertisement image KG may be formed by sealing an illumination film EF on the advertisement display unit 5 to display the advertisement image KG on the illumination film EF as the feature displayed on the advertisement display unit 5.

LED interior light device 20 indicates a device for illuminating an interior including: the set box 15; the plurality of LED tape lights TL; the mobile battery PB and the USB cable UC. Here, illuminating the interior indicates installing the LED illumination device inside the advertisement image KG for illumination from inside.

The mobile advertising holder 100 indicates a holder for advertisement including the advertisement bag 10 and the LED interior light device 20. While the conventional advertisement holder is too heavy to easily carry, that of this embodiment is so light that the problem is overcome, which is to reduce a burden during carrying as much as possible due to the requirement of the set box 15 being made of paper.

In other words, the conventional advertisement holder is too heavy to easily carry while that of this embodiment is so light that the problem is overcome, which is to reduce a burden during carrying as much as possible.

The light diffusion sheet HS indicates an optical sheet configured to diffuse and deform a light by diffusion functions of an array of tiny and random lenses, so as to resolve illumination unevenness and reduce glare and multi-shadow. Since the light is distributed to the required range, an effective illumination can be achieved. The light diffusion sheet HS allows LED lights of RGB each color to be clearly mixed.

The light diffusion sheet HS corresponds to light in a wide range of wavelength (400 nm-1100 nm) and thus uniform transmission is possible in a desired angle. Lenses in micro-sizes are completely randomly arranged on a sheet of polycarbonate or acryl. Thus, it is possible to completely remove illumination unevenness of the light source and to obtain light diffused in arbitrary angles.

Further, the transmission rate is very high (85-92%) and thus it is possible to utilize the light from the light source without redundancy. The main usage is a typical illumination and a light source device for industrial use in a high quality. It is applicable to other various illuminations. The silver sealing indicates sealing pieces of silver paper. The strap unit h indicates a member installed on an upper portion of the advertisement bag 10 to be held by hands.

Description of schematic diagram that depicts connection of mobile battery PB with a plurality of LED tape lights TL: hereinafter, with reference to FIG. 6, a schematic diagram that depicts connection of the mobile battery PB with a plurality of LED tape lights TL is set forth. The mobile battery PB is connected with the USB hub UH via a switch SW using USB cables UC. The USB cables UC connect the USB hub UH with the plurality of LED tape lights TL in parallel.

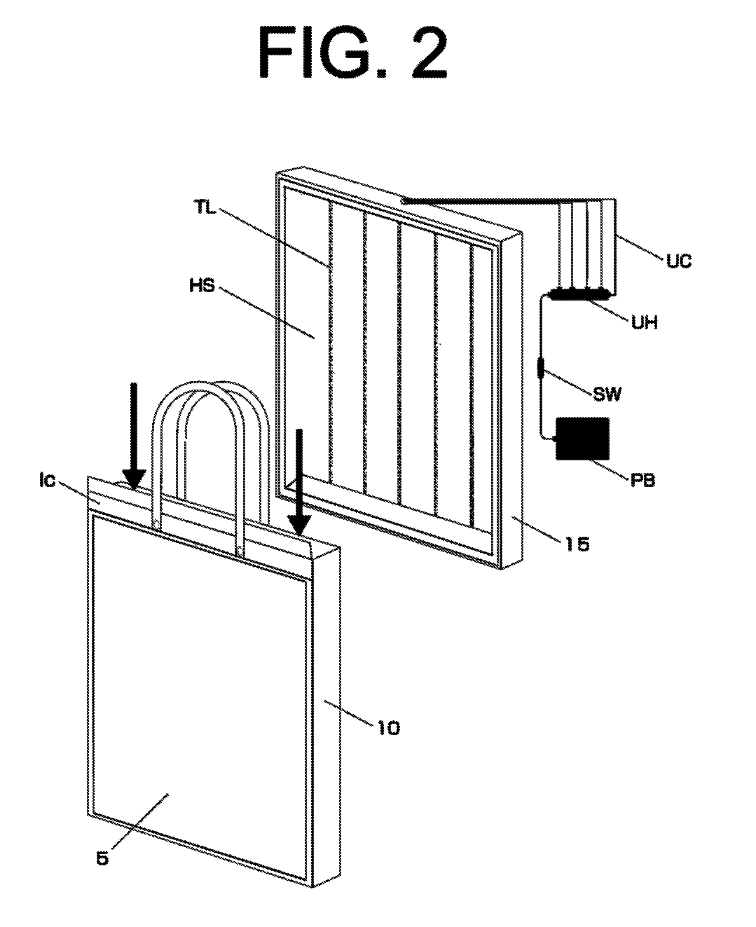

A plurality of bundles of USB cables UC divided from the USB hub UH generally pass through a distribution port arranged on an upper part of the set box 15 to be connected in parallel with a plurality of LED tape lights TL arranged on the back of the set box 15 up and down. However, the embodiment is not limited to this case. Here, upward/downward directions in this embodiment indicate upward/downward directions across the paper on FIGS. 2, 4 and 6.

Hereinafter, an embodiment of the mobile advertisement holder 100 will be set forth with reference to drawings.

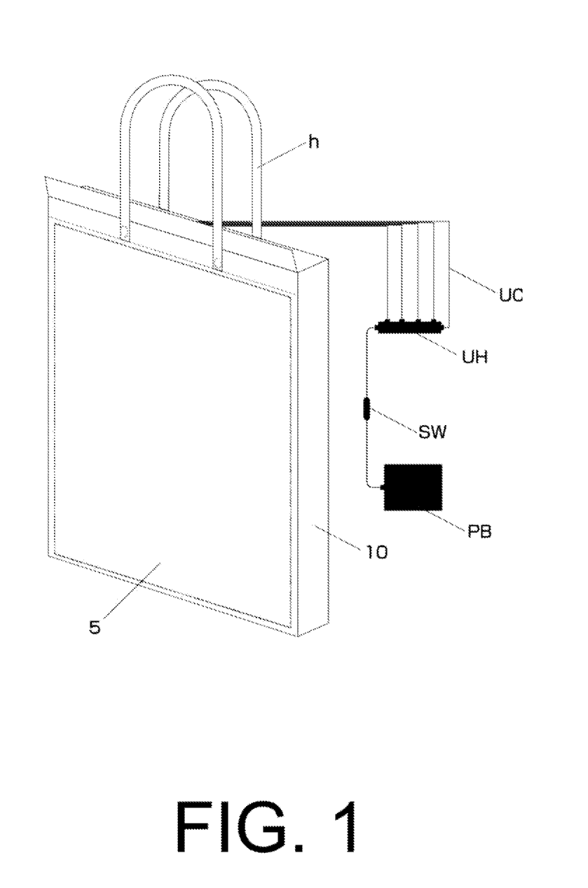

FIG. 1 shows a perspective view of a mobile advertising holder 100. FIG. 2 shows perspective views of a mobile advertising bag 10 and a LED interior light device 10. An arrow indicates storing the LED interior light device 20 in the mobile advertising bag 10.

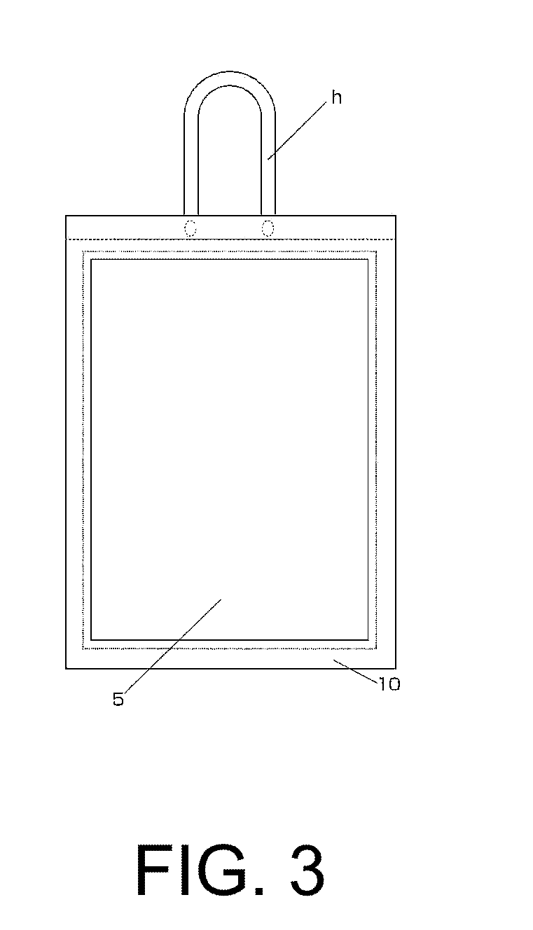

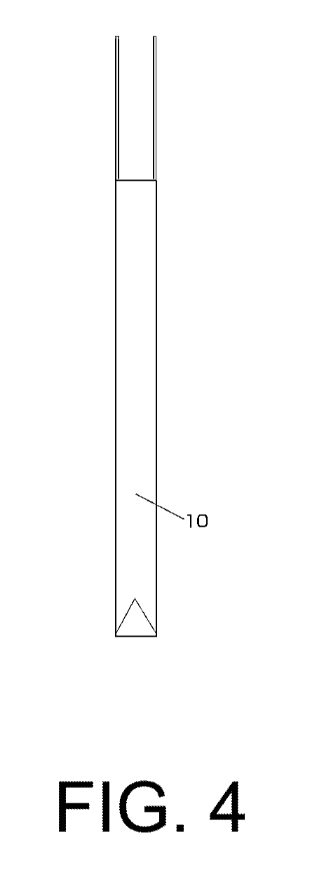

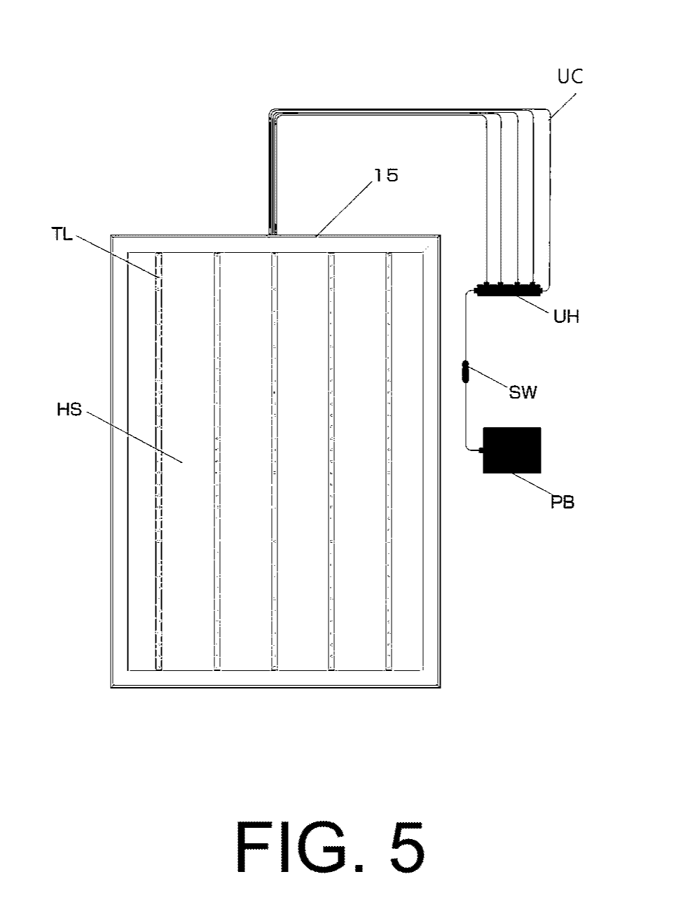

FIG. 3 is a front view of a mobile advertising holder 100. FIG. 4 is a right side view of a mobile advertising holder 100, where the left side view of the mobile advertising holder 100 is symmetrical and thus omitted. FIG. 5 is a front view of a LED interior light device 20.

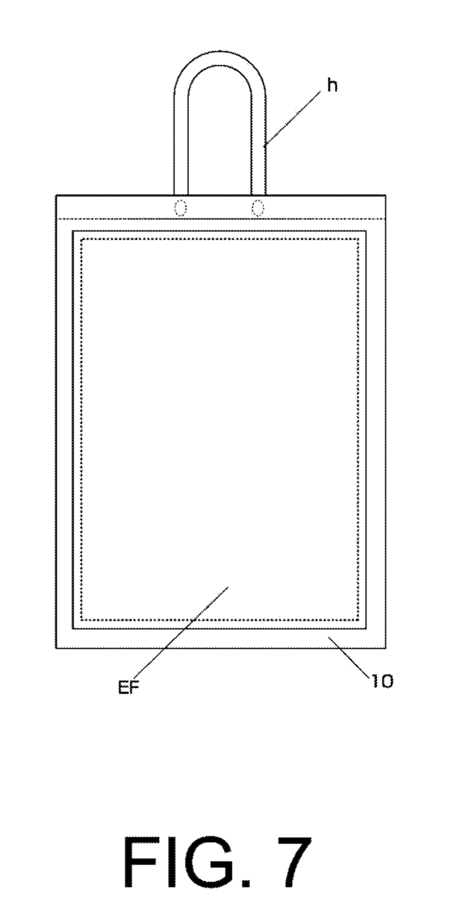

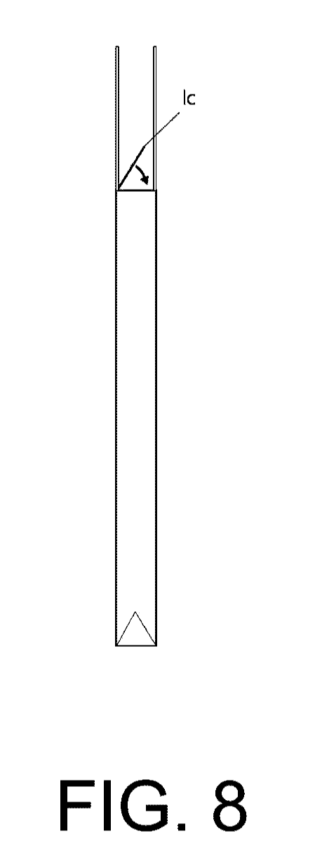

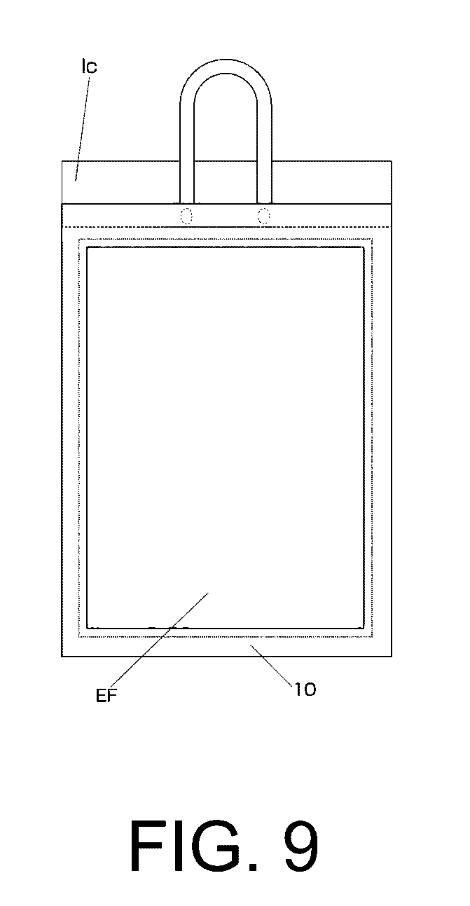

FIG. 6 is a front view of a mobile advertising bag 10. FIG. 7 is a right side view of a mobile advertising bag 10, where the left side view of the mobile advertising bag 10 is symmetrical and thus omitted. FIG. 8 is a front view of a LED interior light device 20, illustrating the LED interior light device 20 provided with a light diffusion sheet HS in front of a set box 15. FIG. 9 is a back view of a mobile advertising bag 10.

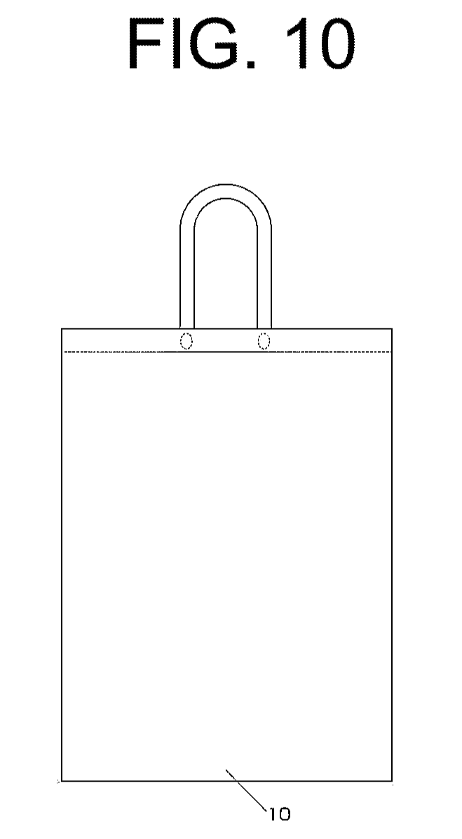

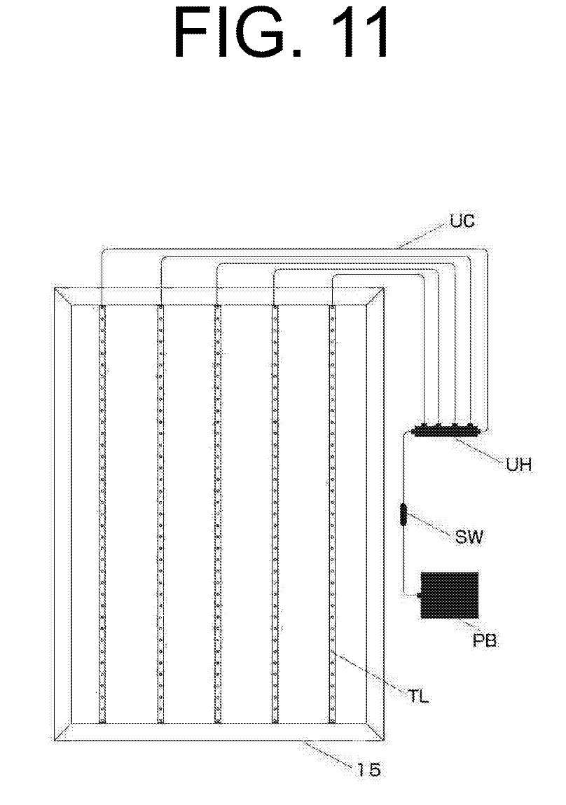

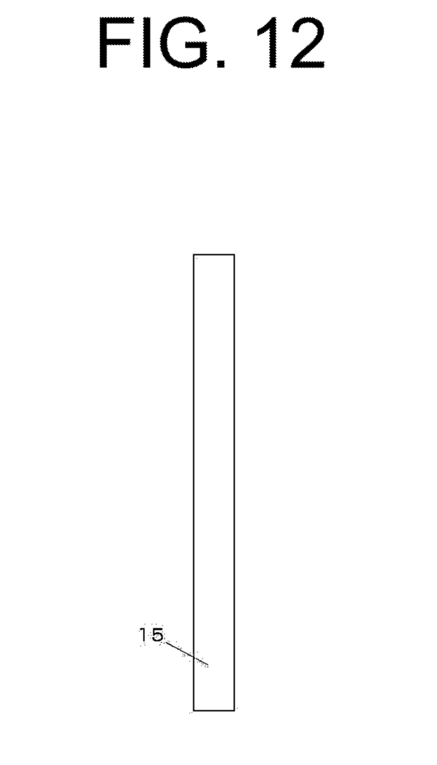

FIG. 10 is a front view of a LED interior light device 20, illustrating the LED interior light device 20 not provided with a light diffusion sheet HS in front of a set box 15. FIG. 11 is a right side view of a LED interior light device 20, where the left side view of the LED interior light device 20 is symmetrical and thus omitted. FIG. 12 is a perspective view of a LED interior light device 20.

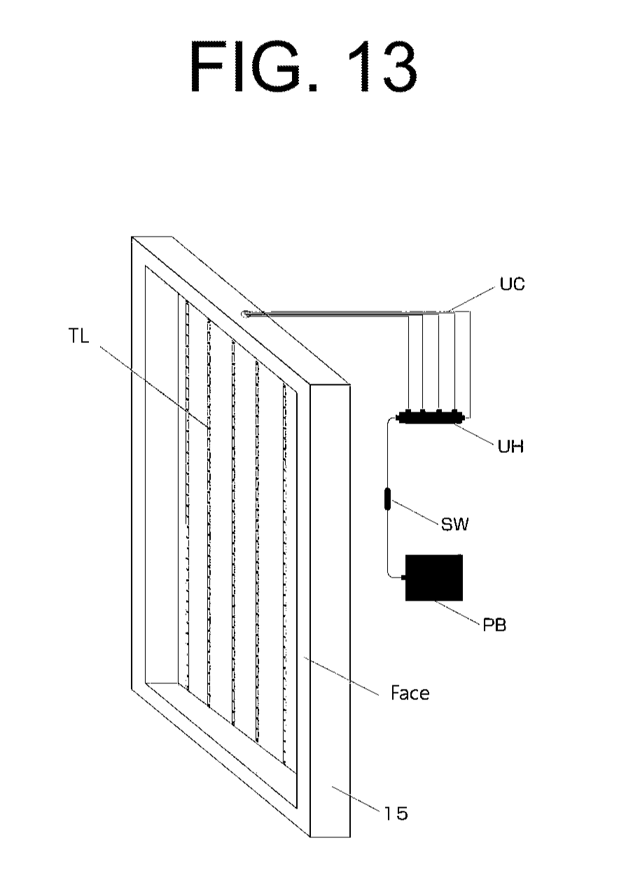

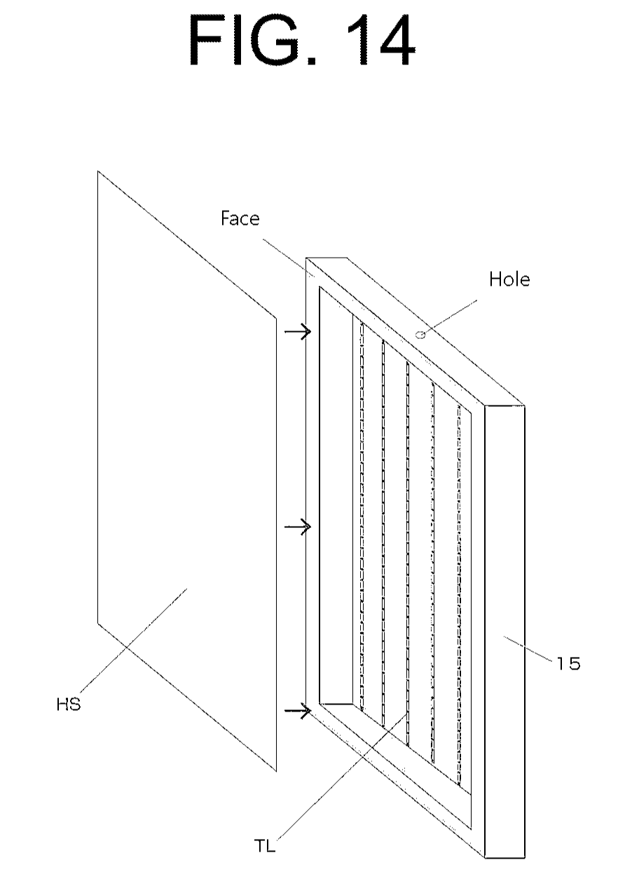

FIG. 13 is a perspective view of a light diffusion sheet HS, where an arrow illustrates an orientation of sealing the light diffusion sheet HS on the frame of the set box 15. FIG. 14 is a tape light TL and a set box 15, where a plurality of LED tape lights TL are arranged and installed on the back of the set box 15 upward/downward, where the LED interior light device 20 is constituted by the tape light TL and the set box 15.

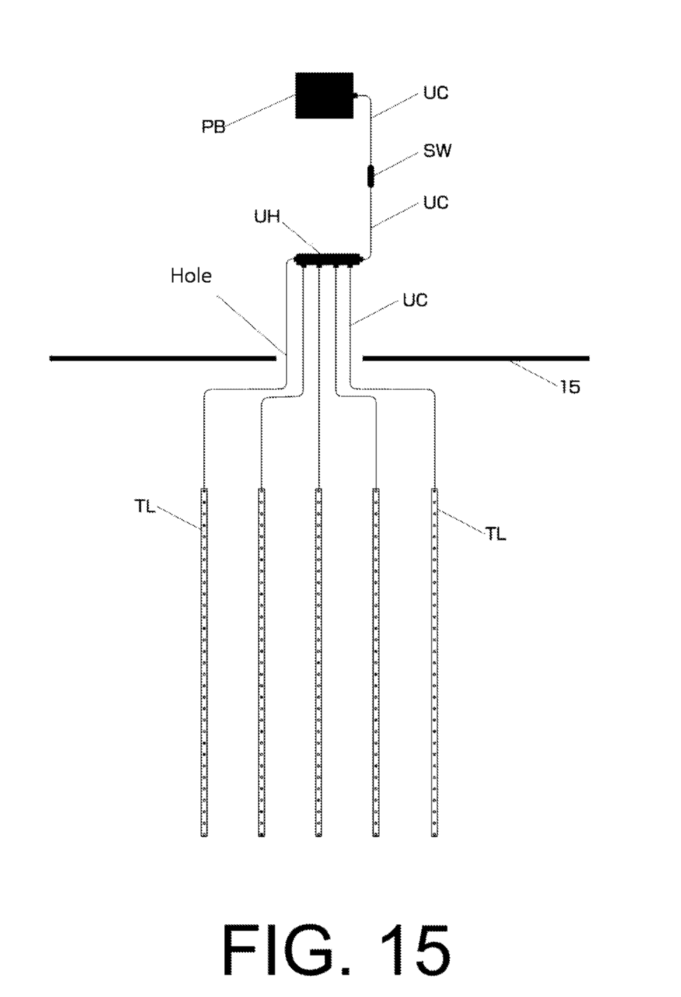

FIG. 15 is a schematic diagram that illustrates connection of a mobile battery PB with a plurality of LED tape lights TL. Hereinafter, the mobile advertisement holder 100 will be set forth with reference to drawings.

The above mobile advertisement holder 100 is a mobile advertisement holder 100 having: an advertisement bag 10 with a strap h; and a LED interior illumination device 20. An advertisement display unit 5 that displays an advertisement image KG is installed in front of the advertisement bag 10. The LED interior illumination device 20 comprises: a set box 15; a plurality of LED tape lights TL; a mobile battery PB; and a USB cable UC. The LED interior illumination device 20 is stored in the advertisement bag 10 so that the plurality of LED tape lights TL illuminate the advertisement image KG of the advertisement display unit 5 to display the advertisement image KG.

The mobile advertisement holder 100 has: an advertisement bag 10 with a strap h; and a LED interior illumination device 20. An advertisement display unit 5 that displays an advertisement image KG is installed in front of the advertisement bag 10. The LED interior illumination device 20 comprises: a set box 15; a plurality of LED tape lights TL; a mobile battery PB; and a USB cable UC. The LED interior illumination device 20 is stored in the advertisement bag 10 so that the plurality of LED tape lights TL illuminate the advertisement image KG of the advertisement display unit 5 to display the advertisement image KG. Due to the above characteristic features, the above first to fifth problems are solved and these effects are prominent.

As a second example embodiment, according to the above mobile advertisement holder 100, a back unit 2, a left side unit 3, a right side unit 4, an upper unit 5, and a bottom unit 6 is made of paper.

According to the above feature, the set box 15 is made of paper. Due to the above characteristic features, the above first to fifth problems are solved and these effects are prominent.

As a third example embodiment, according to the mobile advertisement holder 100, an illumination film EF is sealed on the advertisement display unit 5, and the advertisement image KG is displayed on the illumination film EF.

According to the above feature, an illumination film EF is sealed on the advertisement display unit 5, and the advertisement image KG is displayed on the illumination film EF. Due to the above characteristic features, the above first to fifth problems are solved and these effects are prominent.

As a fourth example embodiment, according to the mobile advertisement holder 100, the advertisement display unit 5 is formed by a sheet material that transmits light.

According to the above feature, the advertisement display unit 5 is formed by a sheet material that transmits light. Due to the above characteristic features, the above first to fifth problems are solved and these effects are prominent.

As a fifth example embodiment, according to the mobile advertisement holder 100, a light diffusion sheet HS is provided in front of the set box 15.

According to the above feature, a light diffusion sheet HS is provided between a front unit 1 and the set box 15. Due to the above characteristic features, the above first to fifth problems are solved and these effects are prominent.

As a sixth example embodiment, according to the mobile advertisement holder 100, an inner side of the set box 15 is sealed by silver material.

According to the above feature, an inner side of the set box 15 is sealed by silver material. Due to the above characteristic features, the above first to fifth problems are solved and these effects are prominent.

As a seventh example embodiment, according to the mobile advertisement holder 100, an upper part of the advertisement bag 10 is provided with a cover 1c for preventing transmission of light.

According to the above feature, an upper part of the advertisement bag 10 is provided with a cover 1c for preventing transmission of light. Due to the above characteristic features, the above first to fifth problems are solved and these effects are prominent.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A mobile advertisement holder comprising:
an advertisement bag includes an advertisement display that displays an advertisement image through a front of the advertisement bag; and
an LED interior illuminator including a plurality of LED tape lights and a mobile battery, wherein the LED interior illuminator faces the advertisement display in the advertisement bag so that the plurality of LED tape lights illuminate the advertisement image of the advertisement display to display the advertisement image.

2. The mobile advertisement holder according to claim 1, wherein the advertisement display includes a set box in which the plurality of LED tape lights are mounted, and wherein the set box is made of paper.

3. The mobile advertisement holder according to claim 1, wherein an illumination film is sealed on the advertisement display, and the advertisement image is displayed on the illumination film.

4. The mobile advertisement holder according to claim 1, wherein the advertisement bag includes a cover on an upper portion of the bag for preventing transmission of light.

5. The mobile advertisement holder according to claim 1, wherein the advertisement display includes a sheet material that transmits light.

6. The mobile advertisement holder according to claim 5, wherein the advertisement display includes a set box in which the plurality of LED tape lights are mounted, and wherein the light diffusion sheet is in front of the set box.

7. The mobile advertisement holder according to claim 6, wherein an inner side of the set box is sealed by silver material.

8. The mobile advertisement holder according to claim 5, wherein the advertisement bag includes a cover on an upper portion of the bag for preventing transmission of light.

9. The mobile advertisement holder according to claim 1, wherein the advertisement display includes a sheet material that transmits light.

10. The mobile advertisement holder according to claim 9, wherein the advertisement display includes a set box in which the plurality of LED tape lights are mounted, and wherein the set box includes a light diffusion sheet.

11. The mobile advertisement holder according to claim 10, wherein an inner side of the set box is sealed by silver material.

12. The mobile advertisement holder according to claim 9, wherein the advertisement bag includes a cover on an upper portion of the bag for preventing transmission of light.

13. The mobile advertisement holder according to claim 1, wherein the advertisement display includes a set box in which the plurality of LED tape lights are mounted, and wherein the set box includes a light diffusion sheet in a front of the set box.

14. The mobile advertisement holder according to claim 13, wherein an inner side of the set box is sealed by silver material.

15. The mobile advertisement holder according to claim 13, wherein the advertisement bag includes a cover on an upper portion of the bag for preventing transmission of light.

16. The mobile advertisement holder according to claim 1, wherein the advertisement display includes a set box in which the plurality of LED tape lights are mounted, and wherein an inner side of the set box is sealed by silver material.

17. The mobile advertisement holder according to claim 16, wherein the advertisement bag includes a cover on an upper portion of the bag for preventing transmission of light.

18. A personal article comprising:
a personal bag body with handle for carrying the article by hand, wherein the personal bag body includes a set box visible through a front of the personal bag body in which a plurality of LED lights are mounted to display an advertisement image through a front of the advertisement bag; and
a cover attached to a top portion of the personal bag body shaped to extend over and block the set box.

19. The personal article of claim 18, wherein the set box includes a front film that transparently completes the front of the personal body bag.

20. The personal article of claim 18, further comprising:
a mobile battery powering the LED lights; and
a USB cable connected to the mobile battery.
